(19) United States
(12) Patent Application Publication
(10) Pub. No.: US 2014/0078565 A1
(43) Pub. Date: Mar. 20, 2014

(54) IMAGE INFORMATION PROCESSING DEVICE

(71) Applicants: Toshiba Tec Kabushiki Kaisha, Tokyo (JP); KABUSHIKI KAISHA TOSHIBA, Tokyo (JP)

(72) Inventor: Akihiko FUJIWARA, Kanagawa (JP)

(73) Assignees: Toshiba Tec Kabushiki Kaisha, Tokyo (JP); KABUSHIKI KAISHA TOSHIBA, Tokyo (JP)

(21) Appl. No.: 14/012,160

(22) Filed: Aug. 28, 2013

(30) Foreign Application Priority Data
Sep. 19, 2012 (JP) 2012-205297

(51) Int. Cl. H04N 1/58

(52) U.S. Cl. CPC H04N 1/58
USPC 358/505

(57) ABSTRACT

According to one embodiment, an image processing device includes a scanning unit configured to scan an image formed on a medium and create image data corresponding to the image, an analyzing unit configured to analyze the image data, a determination unit configured to determine whether or not a portion of the scanned image meets a predetermined condition based on the analyzed image data, and an image correction unit configured to correct the image data so that a portion of the scanned image based on which the determination unit determines meets the predetermined condition is removed from the scanned image.

### CROSS-REFERENCE TO RELATED APPLICATION

This application is based upon and claims the benefit of priority from Japanese Patent Application No. 2012-205297, filed Sep. 19, 2012, the entire contents of which are incorporated herein by reference.

### FIELD

Embodiments described herein relate generally to an image processing of an image formed of an erasable material.

### BACKGROUND

In an image forming apparatus employing an electrophotographic method, an image maybe printed on a medium such as a sheet or the like using, for example, an erasable toner. In such a case, printed contents are made not visible by heating the erasable toner on the medium with an erasing device, for example, to change the characteristics of the erasable toner. Such a medium is often recycled for printing using the image forming apparatus and erasing using the erasing device. As printing and erasing are repeated, a state of the medium gradually deteriorates and a part of the printed image tends to remain even after erasing. For this reason, it may not be easy to read a printed document and the printed document may be misread by a scanner or the like, when a new image is printed on a medium having an old image that is not erased.

A sheet deterioration mark may be printed during each printing in order to determine a deterioration degree of a medium based on an integrated printing ratio. A use of the sheet deterioration mark enables an estimation of a deterioration of a sheet, but it cannot be used to accurately read a new image printed on a sheet on which an old image that is not erased still remains.

### DESCRIPTION OF THE DRAWINGS

FIG. 1 is a block diagram illustrating an image processing device according to a first embodiment.

FIG. 2 is a flowchart illustrating a flow of an image correction optimizing operation in an image processing device shown in FIG. 1.

FIG. 3 illustrates a questionnaire printed with an erasable color material on an unused sheet.

FIG. 4 illustrates an example of a sheet on which the questionnaire shown in FIG. 3 partially remains after an erasing process is performed by an erasing device.

FIG. 5 illustrates a partial view of the sheet shown in FIG. 4 on which an image is newly formed.

FIG. 6 illustrates a part of a questionnaire sheet printed with an erasable color material on an unused sheet according to another embodiment.

FIG. 7 illustrates an example of a sheet on which the questionnaire shown in FIG. 6 partially remains after the erasing process is performed by the erasing device.

### DETAILED DESCRIPTION

In general, embodiments described in the present disclosure are directed to reduce the influence of noise such as a remaining color material after erasing or the like, and to accurately read a new image when the new image is printed on a recycled medium such as a sheet on which printing has been performed using an erasable color material, or the like.

An image processing device according to one embodiment includes an image processing device includes a scanning unit configured to scan an image formed on a medium and create image data corresponding to the image, an analyzing unit configured to analyze the image data, a determination unit configured to determine whether or not a portion of the scanned image meets a predetermined condition based on the analyzed image data, and an image correction unit configured to correct the image data so that a portion of the scanned image based on which the determination unit determines meets the predetermined condition is removed from the scanned image.

Hereinafter, an image processing device according to embodiments will be described with reference to the drawings.

### First Embodiment

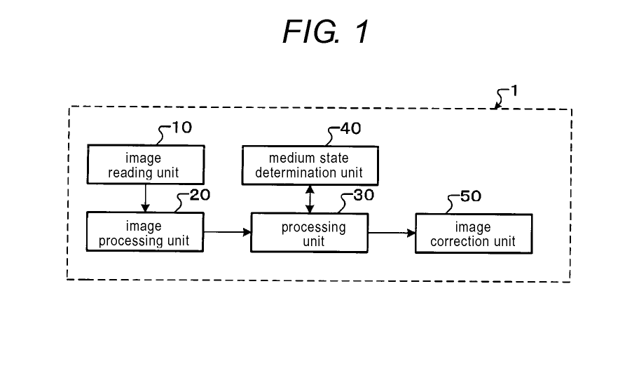

FIG. 1 is a block diagram illustrating an image processing device according to a first embodiment.

In FIG. 1, an image processing device 1 includes an image reading unit 10 which reads an image of an original document, an image processing unit 20 which performs image processing such as OCR (optical character recognition) or OMR (optical mark recognition) with respect to image data which is read by the image reading unit 10, a medium state determination unit 40 which determines a deterioration degree of a sheet (medium) of the original document based on an image processing result of the image processing unit 20, an image correction unit 50 which performs a correction such as filtering or the like with respect to the image data based on the determination result of the medium state determination unit 40, and a processing unit 30 which controls and executes operations of each unit in a processing device such as a CPU.

The image processing device 1 is able to perform optimal image processing by determining a degree of a medium deterioration which is caused by repeating printing and erasing processes, and by performing an appropriate image processing.

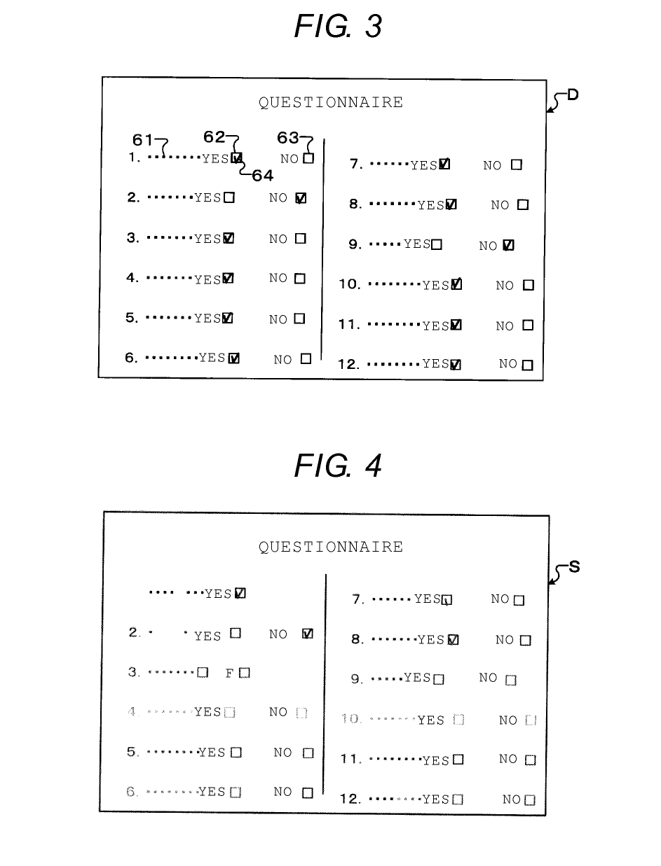

An original document which is read in the image reading unit 10 is assumed to be a questionnaire sheet D as illustrated in FIG. 3, for example. Further, a sheet on which the questionnaire D illustrated in FIG. 3 is printed is assumed to be an unused sheet, and twelve items 61 as illustrated in FIG. 3 are assumed to be printed using an erasable color material by an image forming apparatus (not shown). Each item includes a check box 62 of “Yes” and a check box 63 of “No” and either “Yes” or “No” is chosen. In addition, a respondent fills in a check mark 64 in one of the check boxes 62 and 63 using an erasable pen which uses an erasable color material as ink. In addition, there is no case in which both of the check boxes 62 and 63 of one item 61 are filled in with the check mark 64.

In addition, it is possible to obtain computerized image data by scanning the questionnaire sheet D, on which answers are marked, using the image reading unit 10. Regarding the scanning, it is possible to only perform the scanning of the answers to the questionnaire without erasing the answers, or to perform the scanning of the image using the image reading unit as well as erasing of the image using an erasing device.

Here, when the questionnaire sheet D illustrated in FIG. 3 is heated at an erasable temperature, the image formed on the sheet is erased in an erasing unit of an erasing device (not shown). When the sheet is recycled by repeating the erasing and the image forming, there is a case in which a part of the image formed on a recycled sheet S is not completely erased and remains even after the erasing process is carried out, as illustrated in FIG. 4, for example.

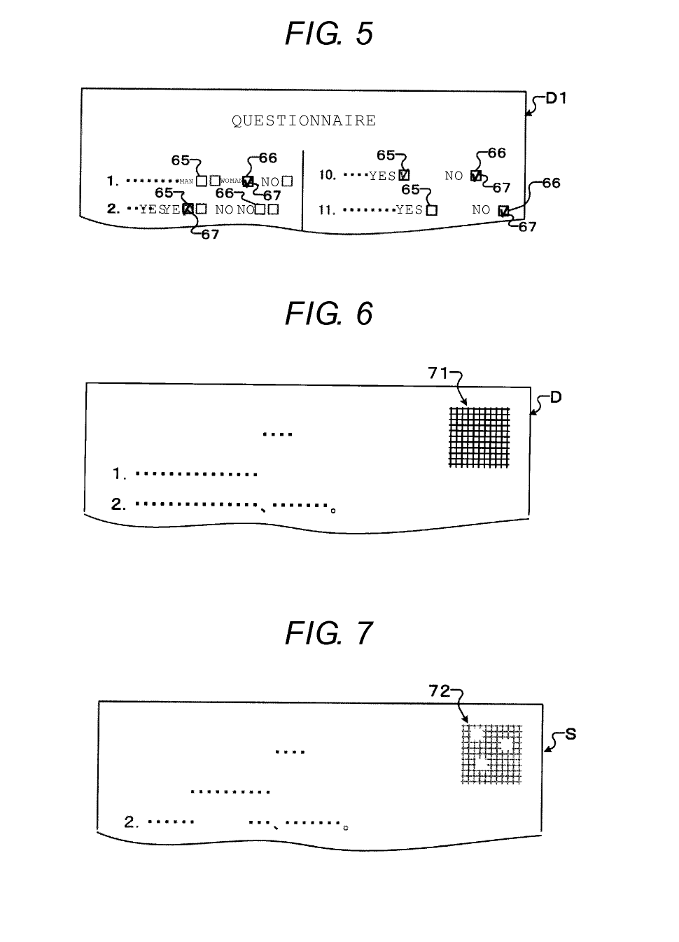

For this reason, when an image for a questionnaire is printed using an image forming apparatus on a recycled sheet on which an image after erasing, which is illustrated in FIG. 4, is remaining, there is a case in which the remaining image after erasing overlaps with the check boxes 65 or 66 in a question item of a questionnaire sheet D1 illustrated in FIG. 5, for example. For example, with respect to a question item 1, a respondent places a check mark 67 in the check box 66 corresponding to “woman,” but another check mark remaining after the erasing overlaps with the check box 65 corresponding to “man.” Because of this, when the question item 1 is read by the image reading unit 10, the question item is read as a state in which both check boxes 65 and 66 are checked. With respect to a question item 2, the check mark 67 is placed in the check box 65, but another check mark remaining after the erasing overlaps with the check box 66. Similarly, with respect to a question item 10, a remaining image after the erasing overlaps with the check box 65. With respect to a question item 11, a remaining image after the erasing is not present in both the check boxes 65 and 66. A density of a remaining image after the erasing, which overlaps with the check box, is not uniform and may be thinner or thicker. In addition, sheets which are read by the image reading unit may include the sheets D as illustrated in FIG. 3, or the questionnaire sheets D1 of a recycled sheet as illustrated in

FIG. 5. Further, with respect to the questionnaire sheets D1 of the recycled sheets, the number of times of recycling is done varies in general.

In the image processing unit 20, the check mark images are automatically detected using a technology of an image processing such as a technology of Optical Mark Reader (OMR) or the like. For example, spaces for entering an answer (Yes or No) with respect to each question item in the questionnaire sheet D illustrated in FIG. 3 (i.e., the check boxed 62 and 63) are automatically detected. Since positions of the check boxes 62 and 63 in the space for entering answers are detected in FIG. 3, it is possible to recognize which check box is checked by detecting a position of the check mark 64.

On the other hand, positions of the check boxes 65 and 66 corresponding to answer spaces for question items which are printed on the questionnaire sheet D1 illustrated in FIG. 5 can be detected, as well. However, there is a case in which it is determined that two check boxes are checked for a question.

According to the embodiment, when two images are present in two check boxes 65 and 66, which are printed in the answer spaces with respect to each question item, it can be interpreted that one image is an actual check mark 67 made by the respondent and that the other image is a remaining image after the erasing. In this case, it is possible to determine that an image of a thicker density is an image of the actual check mark 67, and an image of a thinner density is the remaining image after the erasing.

Accordingly, gray-scale processing (for example, 256 gray scale) is performed on the image data read by the image reading unit 10, and the image data after the gray-scale processing is performed is subject to binarization. By appropriately changing a threshold value for the binarization, it is possible to perform an optimal image correction in which image data of a lower gray scale corresponding to a remaining image after the erasing, which is one of the images present in the check boxes 65 and 66, is removed, and only the actual check mark 67 is determined to be present. By this process, it is possible to improve precision in recognizing the actual check mark.

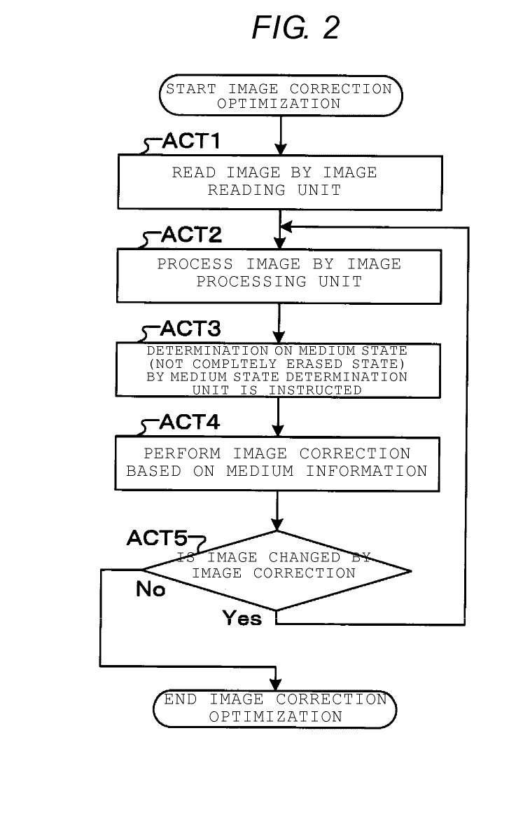

It is needed to optimally perform the image correction such that the precision in recognizing the actual check mark is not affected even when a state of the sheet gets worse. A flow of optimization processing of the image correction using a CPU 30 will be described based on a flowchart in FIG. 2.

In FIG. 2, the questionnaire sheet as an original document to be read is read by the image reading unit 10 in ACT 1, firstly, and then the process proceeds to ACT 2.

In ACT 2, a start of the image processing is instructed to the image processing unit 20, and then the process proceeds to ACT 3. In ACT 2, it is assumed that the start of image processing in which automatic distinguishing of answers in the answer spaces is performed using the OMR technology is instructed with respect to an image of the filled-out questionnaire sheet which is scanned by the image reading unit 10, and on which printing and answer marking are performed using an erasable color material. As a form of the questionnaire sheet, check boxes in which a check mark is supposed to be checked are arranged with respect to each question item, as illustrated in FIGS. 3 to 5. An answerer checks a check mark in a check box corresponding to an answer to the question. In the question item 1 in FIG. 5, the question is about “gender”, and “man” or “woman” as an item for answering is assumed to be arranged. When the answerer answers the question, the answer for the question has to be one check mark on one two answer items. That is, as an answer for the question, there is no case in which both the boxes are checked in case of a reasonable answer.

Accordingly, when it is determined that both the check boxes are checked as a result of the image processing by the image processing unit 20, there is a possibility of recognizing by mistake that a check box which is actually blank is checked since a state of the sheet is deteriorated. Here, it is assumed that a noise is mixed with image data due to the deteriorated sheet state, and a portion at which the noise exists is determined to be a marked portion by mistake in a process of image processing of OMR.

In ACT 3, the medium state determination unit 40 is informed of the image processing result, and is instructed to determine the medium state, and then the process proceeds to ACT 4. In ACT 3, it is assumed that a result of determination regarding a question of asking about “gender” is informed as both “Man” and “Woman”.

The medium state determination unit 40 recognizes that the determination result in which both the check boxes are checked as an answer for the question about “gender” is invalid as a reasonable answer. Here, it is possible to register an invalid answer pattern with respect to an answer for a specific question item like this case, and it is also possible to make a determination by arranging a dummy check box for the determination, leaving the check box blank, and monitoring a state of the check box. In this manner, it is determined that the state of the sheet as a medium is deteriorated since the answer is invalid.

In ACT 4, the image correction unit 50 is informed of the determination result of the medium state, and is instructed to perform an image correction, and then the process proceeds to ACT 5. In ACT 4, it is assumed that a noise is mixed with the image data since the sheet state is deteriorated. For example, there is a case in which a remaining erasable color material or a remaining resin as a base material of toner, which remain on the sheet, are read as noise of image data when scanning. In such a case, the image data includes a noise by which isolated points are scattered in the image, and there is a case in which, when an isolated point overlaps with the check box, the check box is determined to be “checked” by the image processing unit 20 in ACT 2. By performing an image correction of removing such isolated points, it is possible to obtain a correct determination result of image processing. Here, it is possible to remove the isolated points on the base portion which is not a printing and filling out portion of the image data by applying a low pass filter.

In ACT 5, when the correction is applied to the image data in this manner (Yes in ACT 5), the process returns to ACT 2, and the processes of ACTS 2 to 4 are performed. That is, an evaluation of the medium state determination is repeatedly performed with respect to the determination result. With respect to the correction processing, it is possible to set an optimal filtering value, for example, when image corrections are performed so that a cutoff frequency in the low pass filter in each image correction is changed by a certain value in a certain range.

Such a correction processing of removing the isolated points is executed with respect to the question item 1 in FIG. 5, for example, and then the same correction processing is performed with respect to another question item for which it is determined that two check marks are present in the answer spaces. When the image correction is performed with respect to all answer spaces in which a degree of deterioration of the medium is determined to be high, the image correction optimization processing is ended.

According to the first embodiment, when a presence of an image is recognized in both the check boxes which are two alternatives in the answer space printed in the questionnaire sheet, it is possible to recognize an actual answer, and to reliably perform the determination in the image processing unit 20 by determining that the degree of deterioration of the medium is high, and performing image processing so that an image with low density is removed.

### Second Embodiment

FIG. 6 illustrates an original document D used in a second embodiment, and FIG. 7 illustrates a recycled sheet S corresponding to the original document D in FIG. 6 on which erasing process using an erasing device is performed.

The original document D illustrated in FIG. 6 has an identification mark 71 such as a QR code (registered trade mark) along with an image printed by an image forming apparatus using an erasable color material on an unused sheet. In addition, the identification mark 71 is also printed in a second printing and thereafter. In addition, when erasing and image forming using an erasing device are repeated on the unused sheet, as illustrated in FIG. 7, there is a case in which an image is not completely erased and remains on the sheet S. An unerased identification mark 72 is remaining on the sheet S illustrated in FIG. 7 due to repeat of the recycling. The unerased identification mark 72 has lower density as a whole, and apart thereof is completely erased.

Assuming that the image of the identification mark 71 illustrated in FIG. 6 denotes identification information of 100%, if the image of the unerased identification mark 72 illustrated in FIG. 7 is read by the image reading unit 10 of the image processing device 1 illustrated in FIG. 1, it is not possible to read the whole identification information. Instead, it is possible to read the identification information of A (A<100%) % in total including erased portions and portions density of which are reduced.

Accordingly, it is possible to remove noise caused by an unerased image which remains on a recycled sheet, and to read only a newly printed image formed on the recycled sheet by using the value of A % to determine a cutoff frequency in the above described low pass filter or a threshold value for the binarization processing.

In addition, the identification mark such as the QR code is described as an example in order to determine a state of a medium, and this invention is not limited to this. Thus, it is also possible to use a mark which is printed in the medium, or a given carved seal.

According to the embodiment, a case in which functions for executing the exemplary embodiment is recorded in the device in advance is described, and this invention is not limited to this. The same functions may be downloaded to the device from a network, or a recording medium in which the same functions are stored may be installed in the device. The recording medium may be of any type, if the recording medium can store a program like a CD-ROM and the device can read the recording medium. In addition, the functions which are obtained by installing or downloading in advance in this manner maybe executed by collaborating with an operating system (OS) or the like in the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. An image processing device comprising:
a scanning unit configured to scan an image formed on a medium and create image data corresponding to the image;
an analyzing unit configured to analyze the image data;
a determination unit configured to determine whether or not a portion of the scanned image meets a predetermined condition based on the analyzed image data; and
an image correction unit configured to correct the image data so that a portion of the scanned image based on which the determination unit determines meets the predetermined condition is removed from the scanned image.

2. The image processing device according to claim 1, wherein
the predetermined condition is that the portion of the scanned image is formed in a specific position of the scanned image.

3. The image processing device according to claim 2, wherein
the specific position is a position of the image at which the determination unit determines that a portion of the image is not supposed to be formed.

4. The image processing device according to claim 1, wherein
the scanned image includes plural answer spaces for a question and a portion of the image formed in at least one of the answer spaces, and wherein
the analyzing unit is configured to analyze whether or not the answer spaces is formed in the scanned image and whether or not a portion of the image is formed in each of the answer spaces,
the determination unit determines that the portion of the image meets the predetermined condition if a portion of the image is formed in each of the answer spaces, and
the image correction unit corrects the image data so that one of the portions of the image formed in the answer spaces is removed from the scanned image.

5. The image processing device according to claim 4, wherein
a density of the portion of the image removed from the scanned image is less than a density of the portion of the image remaining in the scanned image.

6. The image processing device according to claim 4, wherein
a density of the portion of the image removed from the scanned image is less than a predetermined density.

7. The image processing device according to claim 6, wherein
the predetermined density is a density of an image that is formed of an erasable material and remains after the image has been subject to a heat by which an image erasing apparatus erases an image formed of the erasable material.

8. A method for processing an image comprising:
scanning an image formed on a medium to create image data corresponding to the image;
analyzing the scanned image data;
determining whether or not a portion of the scanned image meets a predetermined condition based on the analyzed image data; and
correcting the image data so that a portion of the scanned image that is determined to meet the predetermined condition is removed from the scanned image.

9. The method of claim 8, wherein
the predetermined condition is that the portion of the scanned image is formed in a specific position of the scanned image.

10. The method of claim 9, wherein
the specific position is a position of the image at which the portion of the image is not supposed to be formed.

11. The method of claim 8, wherein
the scanned image includes plural answer spaces for a question and a portion of the image formed in at least one of the answer spaces, and wherein
the crated image data is analyzed by analyzing whether or not the answer spaces are formed in the scanned image and whether or not a portion of the image is formed in each of the answer spaces,
the portion of the image is determined to meet the predetermined condition if a portion of the image is formed in each of the answer spaces, and
the image data is corrected so that one of the portions of the image formed in the answer spaces is removed from the scanned image.

12. The method of claim 11, wherein
a density of the portion of the image removed from the scanned image is less than a density of the portion of the image remaining in the scanned image.

13. The method of claim 11, wherein
a density of the portion of the image removed from the scanned image is less than a predetermined density.

14. The method of claim 13, wherein
the predetermined density is a density of an image that is formed of an erasable material and remains after the image has been subject to a heat by which an image erasing apparatus erases an image formed of the erasable material.

15. A method for processing image data acquired from an image formed on a medium comprising:
analyzing the acquired image data;
determining whether or not a portion of the scanned image meets a predetermined condition based on the analyzed image data; and
correcting the image data so that a portion of the scanned image that is determined to meet the predetermined condition is removed from the acquired image.

16. The method of claim 15, wherein
the predetermined condition is that the portion of the image is formed in a specific position of the acquired image.

17. The method of claim 16, wherein
the specific position is a position of the image at which the portion of the image is not supposed to be formed.

18. The method of claim 15, wherein
the scanned image includes plural answer spaces for a question and a portion of the image formed in at least one of the answer spaces, and wherein
the crated image data is analyzed by analyzing whether or not the answer spaces are formed in the acquired image and whether or not a portion of the image is formed in each of the answer spaces,
the portion of the image is determined to meet the predetermined condition if a portion of the image is formed in each of the answer spaces, and
the image data is corrected so that one of the portions of the image formed in the answer spaces is removed from the acquired image.

19. The method of claim 18, wherein
a density of the portion of the image removed from the acquired image is less than a density of the portion of the image remaining in the acquired image.

20. The method of claim 19, wherein
a density of the portion of the image removed from the acquired image is less than a predetermined density.
